(19) United States
(12) Patent Application Publication
(10) Pub. No.: US 2001/0027418 A1
(43) Pub. Date: Oct. 4, 2001

(54) System and methods for on-line, real-time inventory display, monitoring, and control

(76) Inventor: Ronald Fredrik Michael Johnson, Whittier, CA (US)

Correspondence Address: GREENBERG-TRAURIG, 1750 TYSONS BOULEVARD, 12TH FLOOR, MCLEAN, VA, 22102, US

(21) Appl. No.: 09/769,294

(22) Filed: Jan. 26, 2001

Related U.S. Application Data
(60) Provisional application No. 60/178,313, filed on Jan. 27, 2000.

(51) Int. Cl. G06F 17/60

(52) U.S. Cl. 705/22

(57) ABSTRACT

Systems and methods are disclosed which allow on-line, real-time monitoring and control of inventory information. Inventory may be monitored through a web page or other database interface, thereby giving access to precise inventory information. Inventory information may be adjusted at various times throughout the receiving/order fulfillment/shipping process. Access to information stored in a database may be controlled on a user-by-user basis. By providing accurate, real-time inventory information to on-line customers, the present invention may improve customer service, give customers reasonable expectations, and help companies automate many of their shipping and receiving functions.

### PRIORITY CLAIM

The present invention claims priority from U.S. provisional application Ser. No. 60/178,313, filed Jan. 27, 2000, the contents of which, including all Appendices and Figures, are incorporated herein by reference.

### FIELD OF THE INVENTION

The present invention relates to the field of electronic inventory management. In particular, the present invention provides systems and methods for real-time monitoring and control of inventory involved in on-line purchases.

### BACKGROUND OF THE INVENTION

The past few years have seen the advent of a new way of shopping; placing orders on-line via the Internet. The Internet provides an attractive means of selling products, due to the vast number of potential clients and the relatively low cost of setting up and maintaining a web site. Because of the accessibility of the Internet, the ease with which comparison shopping can be done, and the ability to have most items shipped to third parties, customers also find shopping attractive.

However, on-line purchasing can present problems for those selling products on the Internet. Typically, customers assume that their order will be filled within a day, and will be at the recipient's door within a week. Unfortunately, on-line orders can easily outpace a company's ability to effectively inform consumers of its inventory. Although some companies have integrated inventory information into their web site, that information is typically not updated in real-time, nor is the information entirely accurate. Most web sites incorporating inventory information typically show static information which is based on queries run at the end of some predetermined period. Most in the prior art typically run such queries at the end of the day or at the end of the week. In addition, inventory information is typically limited to whether or not an item is “in stock”, and does not indicate a quantity available for purchase.

Without accurate information, customers may initially have high expectations of a company's ability to deliver products. However, those expectations may soon be dashed, and a customer may become disenchanted with a company, when an anticipated delivery schedule is not met due to insufficient stock.

### SUMMARY OF THE INVENTION

The present invention provides a system and method for allowing on-line, real-time monitoring and control of inventory information. Inventory information may be monitored or displayed through a web page or other user interface. A web page displaying inventory information may allow a user to view all available inventory, or select portions of the available inventory through filters.

Inventory information may be retrieved from one or more databases acting as part of the present invention. Available inventory information may include, but is not limited to, items presently in stock, number of items ordered, number of items shipped, number of items on order from supplier, anticipated date of receipt from supplier, number of items received in last shipment, and last shipment receipt date.

An inventory database may be an integral part of shipping, receiving, and order processing. Inventory information may be adjusted at various times throughout a process, such as when new items are ordered from suppliers, new items are received from suppliers, new orders are received from customers, orders are shipped to customers, and other, similar events.

Inventory information may be stored in a single file, multiple files, or in a structured database as a single table or multiple tables. Visitors to an Internet site may be given access to some or all information stored in a database. Additionally, access to some data may be granted on a user-by-user basis.

By providing accurate, real-time inventory information to on-line customers, the present invention improves customer service, gives customers reasonable expectations, and helps companies automate many shipping and receiving functions.

### BRIEF DESCRIPTION OF THE DRAWINGS

FIG. 1 is a flowchart illustrating an inventory tracking technique implemented in a preferred embodiment of the present invention.

FIG. 2 is a block diagram illustrating a Client/Server topology used in the present invention.

FIG. 3 is a block diagram illustrating a Database Communication Layer as implemented in a preferred embodiment of the present invention.

### DETAILED DESCRIPTION OF THE INVENTION

The present invention allows display, monitoring, and control of detailed inventory records via the Internet or other wired or wireless communications medium. Real-time access to inventory information improves customer confidence in a business due to more reasonable shipping and arrival date expectations for a given order. Information which is accessible through the present invention may include: the number of items available in stock, the number on-reserve by customers, the number on order from suppliers, anticipated date of receipt for items on order, and other related information.

In a preferred embodiment, the present invention includes a database with a table in which inventory can be tracked. An inventory table can include fields for tracking various information, such as, but not limited to, product name, manufacturer, model number, inventory number, description, price per unit, quantity on-hand, quantity on-reserve, quantity on order, and anticipated restocking date. When a web site visitor requests information about a product or group of products, appropriate entries may be retrieved from an inventory table. A web site visitor may see the difference between quantity on-hand and quantity on-reserve as a quantity available.

When a quantity on-reserve approaches the quantity on-hand, an automatic order may be placed with an appropriate supplier to replenish stock. Sales rates, unit cost, and other factors may be used to determine appropriate minimum stock on-hand levels which trigger supplier orders. When a shipment is received from a supplier, quantities on-hand of each item received may be appropriately adjusted. Such adjustments may be automated by scanning Universal Product Codes (“UPC codes”) or other electronically readable codes corresponding to items contained in a supplier shipment.

As customer orders are placed, on-reserve counts corresponding to each item ordered may be incremented by quantity ordered. UPC codes or other electronically readable codes corresponding to items comprising a customer order may be scanned or otherwise accounted for as an order is being prepared for shipping. Items for which such electronically readable codes are present may be accounted for through manual data entry or other, similar means. Such manual and electronic accounting may result in reductions of quantities on-hand and on-reserve as reflected in an inventory. This may result in automatic updates to quantities available, as represented on a web site.

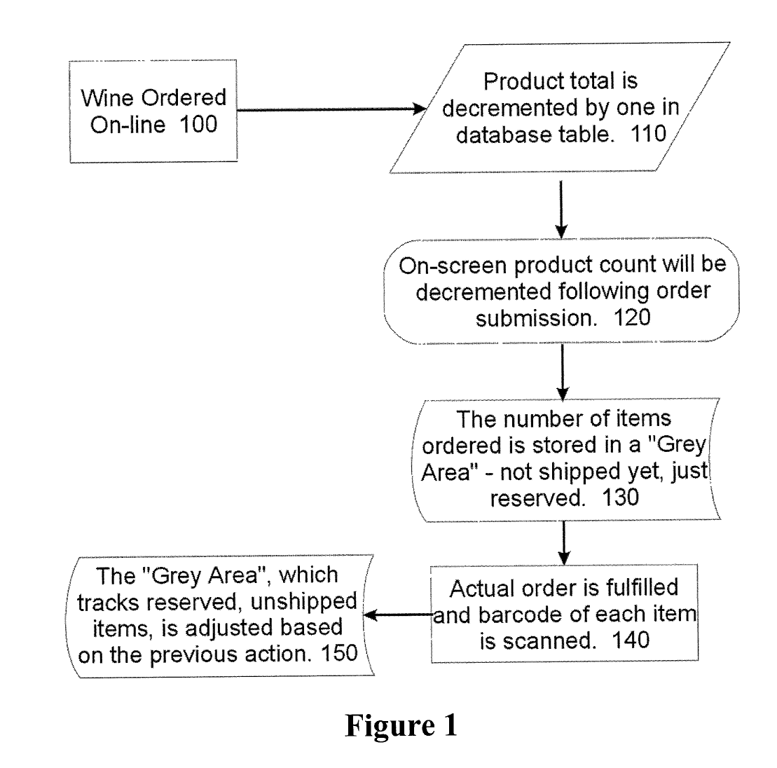

FIG. 1 is a flowchart illustrating an inventory tracking technique implemented in a preferred embodiment of the present invention. When an order is submitted, as illustrated in FIG. 1 by Block 100 (“Wine Ordered 100”), an automatic change to appropriate inventory totals may be made, as illustrated by Block 110 (“Product Total 110”). As illustrated by Block 120, an order confirmation may be displayed after appropriate inventory, payment verification, billing, and other related actions are taken.

Block 130 illustrates previously described inventory tracking functions, in which reserve counts are incremented based on customer orders. Blocks 140 and 150 illustrate previously described shipping procedures. Block 140 illustrates order fulfillment and shipping preparation. Block 150 illustrates previously described database functions, in which both on-hand and on-reserve counts for items included in an order may be adjusted based on shipment contents.

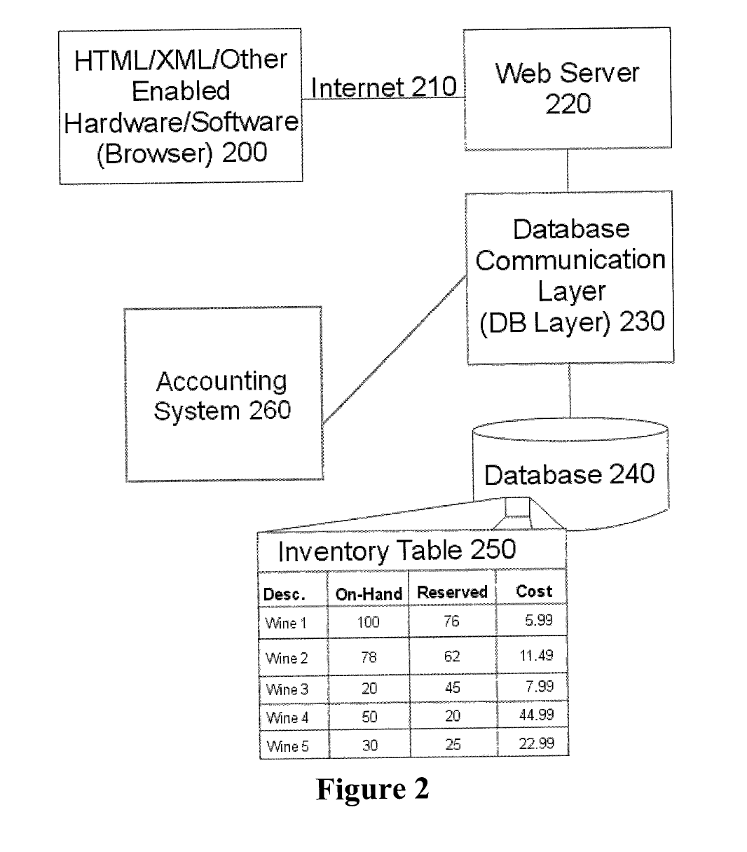

FIG. 2 is a block diagram illustrating a Client/Server topology as used in the present invention. Browser 200 represents a “client”. A client may consist of software, hardware, or combinations thereof, designed into or running on a computer, kiosk, telephone, set-top box, cell phone, handheld computer, or other electronic device, that allows a device to request data from a central point (“server”). Software portions of a client may consist of commercially available software, customized commercial software, custom software, or combinations thereof. In a preferred embodiment, software portions of a client consist of a Java-enabled World Wide Web browser (“web browser”). Examples of typical web browsers include Internet Explorer, manufactured by Microsoft of Seattle, Wash., or Netscape Navigator, manufactured by Netscape of Mountain View, Calif.

Internet 210 represents a communications medium through which data may be transferred between Browser 200 and Web Server 220. Such a communications medium may use wireless or wired means to transfer such data between Browser 200 and Web Server 220. Examples of such a communications medium include, but are not limited to, the high-speed, packet switched network commonly referred to as the Internet; a cellular telephone system; ultra-wide band data transmitters; microwave transmitters; standard telephone systems; satellite telephone systems; infrared transmitters; and bi-directional cable or satellite television systems.

Browser 200 and other clients may utilize Internet 210 to communicate with Web Server 220. Such requests can be initiated by Browser 200 utilizing standardized or proprietary request formats. In a preferred embodiment, Web Server 220 may receive from Browser 200 an Internet Protocol address, cellular telephone number, personal pager number, or other identifier through which Browser 200 may be contacted. With such information, Web Server 220 can update information requested by Browser 200 as such information changes, or “push” said changes to a client. In an alternative embodiment, Browser 200 can provide up-to-date information to a user by periodically request updated information from Web Server 220. This later method may also be referred to as a client “pulling” data from a server.

Web Server 220 illustrates a server as implemented in a preferred embodiment of the present invention. Web Server 220 may contain combinations of data storage elements, processors, software, and the like. Although illustrated as a single item, Web Server 220 may consist of one or more computers, running one or more software applications, over which processing, data storage, and other functions may be distributed. Examples of software which may be run on a typical web server include Microsoft Internet Information Server, Netscape Enterprise Server, and Apache Server, manufactured by The Apache Software Foundation of Lincoln, Nebr.

Typically, web servers deliver content to web browsers as text, graphics, or other media which is encoded in a “markup language.” Markup languages allow clients to convert content from a machine-readable form to a form which can be read, viewed, or otherwise perceived by humans. Examples of current markup languages include, but are not limited to, Hypertext Markup Language (HTML), Standardized Generalized Markup Language (SGML), eXtensible Markup Language (XML), and Portable Document Format (PDF).

Web servers may obtain content from files stored on a hard-drive, Redundant Array of Inexpensive Disks (“RAID array”), or other storage device; or from other sources, such as databases. In a preferred embodiment, the present invention may use a combination of one or more files and one or more databases as content sources.

Web server 220 may also restrict access to files, portions of Database 240, or data from integrated applications such as Accounting System 260, on a user-by-user basis. By allowing customizable access privileges, administrative functions, such as data entry, price adjustments, and the like, may be securely performed through a web browser.

Most web servers do not readily allow communication with a database or with third-party applications, thus additional hardware and/or software must be added to facilitate such communication. DB Layer 230 of FIG. 2 illustrates such software. Microsoft's Active Data Objects (“ADO”) is an example of such a database communication layer. Further, custom software can be developed which allows DB Layer 230 to communicate with third party tools.

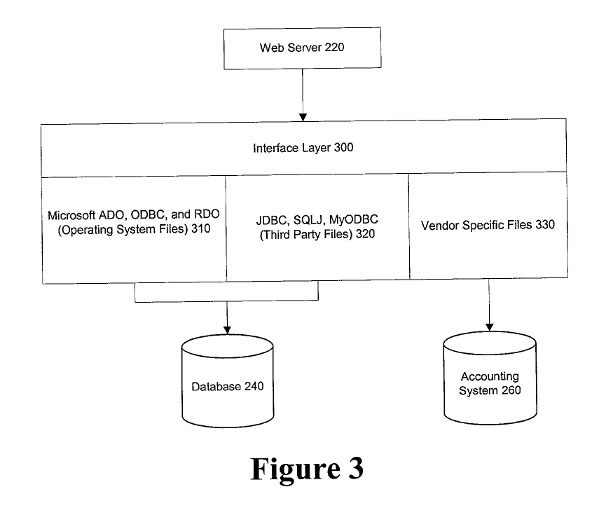

An architecture which can support such functionality is illustrated in FIG. 3. To allow DB Layer 230 to interface with various elements, such as Database 240 or Accounting System 260, DB Layer 230 may utilize an interface layer, such as Interface Layer 300. Interface Layer 300 can provide a standardized set interface with which Web Server 220 can request data from one or more sources.

As illustrated in FIG. 3, Interface Layer 300 may provide access to Database Layer 240 through Operating System Files 310, or through Third Party Files 320. Operating System Files 310 may represent standard database interface methods supported by an operating system, such as Microsoft ODBC, Microsoft ADO, and Microsoft RDO. Third Party Files 320 can also be integrated into DB Layer 230, thereby providing advanced features or functionality unavailable from Operating System Files 310. Examples of interfaces which may be supported by Third Party Files include, but are not limited to, Java Database Connectivity (JDBC), and MyODBC. DB Layer 230 may also allow software vendors to create interfaces between the present invention and their software. Such functionality can allow the present invention to access data stored in Accounting System 260 and other external datasources.

Referring again to FIG. 2, Database 240 represents a database into which inventory, customer, product description, and other data can be stored as a single file or collection of files. In a preferred embodiment, Database 240 can represent a database server, such as, but not limited to, Microsoft's SQL Server, Oracle 8I, manufactured by Oracle Corporation of Redwood Shores, CA, and Sybase Adaptive Server, manufactured by Sybase, Inc. of Emeryville, Calif.

Database servers allow information to be organized into “tables”. Inventory Table 250 illustrates a portion of a table implemented in Database 230. As illustrated in Inventory Table 250, a table may be comprised of “fields,” such as a description, quantity on-hand, quantity on-reserve, and cost per unit.

Accounting System 260 represents a database of accounting or other information that can be maintained external to the present invention. Examples of such accounting databases include, but are not limited to, Quick Books, Quicken Business, and Microsoft Money.

A customer may use Browser 200 to request information about a particular item, or group of items, offered for sale. Browser 200 may relay this request to Web Server 220 via Internet 210. If Web Server 220 can access requested information from files stored external to Database 240, Web Server 220 may provide the information to Browser 200. If a request includes information from Database 240, Web Server 220 may request required information from DB Layer 230.

DB Layer 230 can convert requests from Web Server 220 into a form that may be used by Database 240. Database 240 may retrieve requested information from one or more tables, such as Inventory Table 250. Retrieved information may be passed from Database 240 to Web Server 220 through DB Layer 230. Web Server 220 may relay returned information to Browser 200 via Internet 210.

DB Layer 230 may also translate information received from Web Server 220 into a format that can be understood by Accounting System 260. Such translations may allow Accounting System 260 to integrate more accurately with real-time inventory management systems such as the present invention. This additional functionality can allow an accounting system to automatically prepare payment for new orders as such orders are received from a supplier, to automatically credit a customer account when a return is processed, to begin billing procedures when an order is received or when an order ships, and for other such purposes.

An inventory tracking and inventory management process such as the process illustrated in FIG. 1, combined with a client/server configuration as illustrated in FIG. 2, can provide real-time access to inventory information to online customers. While the preferred embodiment and various alternative embodiments of the invention have been disclosed and described in detail herein, it may be apparent to those skilled in the art that various changes in form and detail may be made therein without departing from the spirit and scope thereof.

I claim as my invention:

1. A real-time inventory management system comprising:
a database, for storing inventory information;
a communication interface, for providing access to said database, said interface communicating between a server and a client;
a server, for providing access to system accessible data, and for performing business logic on such data; and,
a client, for providing a user interface to the system.

2. The real-time inventory management system of claim 1, in which said server is comprised of a web server.

3. The real-time inventory management system of claim 1, in which said client is comprised of a web browser.

4. The real-time inventory management system of claim 1, further comprising a means of wireless communications between a client and a server.

5. The real-time inventory management system of claim 1, in which said client is comprised of a combination of a web browser and custom software for real-time inventory display.

6. The real-time inventory management system of claim 1, in which said client is comprised of a combination of a web browser and custom software for real-time inventory monitoring.

7. The real-time inventory management system of claim 1, in which said client is comprised of a combination of a web browser and custom software for real-time inventory control.

8. The real-time inventory management system of claim 1, in which said client is comprised of a combination of a web browser and custom software for real-time inventory display, monitoring, and control.

9. The real-time inventory management system of claim 1, in which said client includes a device capable of reading container labels.

10. The real-time inventory management system of claim 9, in which said client includes a barcode scanner.

11. The real-time inventory management system of claim 1, in which said client periodically receives or requests inventory updates from said server.

12. A method of real-time inventory management, comprising the steps of:
recording orders and order properties, including quantities ordered, date ordered, anticipated delivery time, and anticipated delivery date in an inventory database;
recording any new or returned inventory arrivals, and incrementing corresponding on-hand inventory entries;
receiving purchase requests and placing corresponding inventory on reserve;
calculating inventory quantities available for delivery as a difference between quantity on-hand and quantity on reserve. decrementing both reserve and inventory totals upon shipment; and
providing user-appropriate inventory information when requested.

13. The real-time inventory management method of claim 12, in which said new inventory orders are entered through an accounting system.

14. The real-time inventory management method of claim 13, wherein said accounting system automatically updates an inventory database.

15. The real-time inventory management method of claim 12, in which electronically readable codes corresponding to inventory items are read by a client as items are received or shipped.

16. The real-time inventory management method of claim 15, in which said electronically readable codes are Universal Product Code (UPC) codes.

17. The real-time inventory management method of claim 12, in which said user-appropriate inventory information is displayed on a client.
